(19) United States
(12) Patent Application Publication
(10) Pub. No.: US 2007/0172905 A1
(43) Pub. Date: Jul. 26, 2007

(54) Method for screening process conditions of a chemical coupling reaction and kits therefor

(75) Inventors: Frederic Taran, Gif Sur Yvette (FR); Christophe Creminon, Orsay (FR); Pierre-Yves Renard, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 10/551,929

(22) PCT Filed: Apr. 13, 2004
(86) PCT No.: PCT/FR04/50158

§ 371 Date: Oct. 10, 2006

(30) Foreign Application Priority Data
Apr. 15, 2003 (FR) 0350106

(51) Int. Cl. C40B 40/04

(52) U.S. Cl. 435/7.92

(57) ABSTRACT

The present invention relates to a method of screening the operating conditions of a coupling reaction of at least two functional groups, and in particular of catalysts that are useful in this coupling reaction, and also to kits suitable for allowing this method to be carried out. Applications: fundamental and applied research, in particular in the areas of chemistry, agrofoods, pharmacy and environmental protection, for the development or optimization of synthesis reaction yields.

This patent application claims the priority of the French patent application filed on Apr. 15, 2003 under no. 03 50106 which is incorporated hereby by reference.

### TECHNICAL FIELD

The present invention relates to a method of screening the operating conditions of a chemical coupling reaction, and also to kits suitable for allowing this method to be carried out.

More precisely, it relates to a method for simultaneously testing the effects of various operating conditions on the yield of a reaction consisting in coupling at least two functional groups with a view, for example, to selecting the one or those of these conditions that result in optimization of this yield.

These operating conditions may be both qualitative and quantitative.

Thus, the method can be used to screen substances, such as catalysts or solvents, for which it is desired to determine whether they are capable of being useful in a particular coupling reaction, but it may also be used for screening levels, for example temperature or pressure levels, concentrations, stoichiometric ratios or times, such as reaction time or stirring time for the reaction medium, for which it is desired to determine the influence on the yield of a coupling reaction.

The method according to the invention is therefore liable to find a large number of applications in the field of research, both fundamental and applied.

Thus, for example, it can be used in fundamental studies aimed at a better understanding of the mechanisms of homogeneous or heterogeneous catalysis, whether chemical or biological.

It can also be used in applied research studies, in particular in the areas of chemistry, agrofoods, pharmacy and in environmental protection, having the aim either of developing catalysts that are more effective and more able to respond specifically to particular constraints, or of optimizing synthesis reaction yields or experimental conditions, with a view, for example, to a decrease in the costs of carrying out these reactions.

In particular, it can be used to screen a library of mutated enzymes in order to improve the catalytic performance levels of a “wild-type” enzyme, or to screen biological media that have a known or unknown composition, with the aim of identifying the existence of a particular catalytic activity in these media.

### STATE OF THE PRIOR ART

In terms of screening the operating conditions of a coupling reaction, these are essentially methods intended to screen catalysts that have been proposed to date.

These methods all comprise a step consisting in reacting two particular compounds, representative of the families of compounds for which the coupling reaction is liable to be used, in the presence of the various candidate catalysts, followed by a step consisting in assessing the effectiveness of these catalysts on said reaction.

Thus, firstly, there are known methods that aim to analyze, at the end of the coupling reaction, the composition of the reaction media by high pressure liquid chromatography (HPLC), which means that they must first be purified, for example by filtration on silica gel columns.

These are therefore methods that are laborious to carry out, that allow only a limited number of tests to be carried per day, and that are, consequently, completely unsuitable for medium- or high-throughput screening.

Secondly, there are existing methods that aim to use, at the end of the coupling reaction, a chemical reaction which is capable of reacting either with one of the compounds involved in this coupling reaction, or with the product or a by-product derived from said reaction, generating a signal such as a coloration, a decoloration, or the emission of a fluorescence or of a chemoluminescence.

By way of examples, mention may be made of:
the method described by Lavastre and Morken in Angew. Chem. Int. Ed., 1999, 38(21), 3163-3165, [1], for screening catalysts that are useful in an allylic alkylation, and which aims to detect the 1-naphthol produced in the course of this alkylation by reacting it with the diazonium salt known as “Fast Red Violet LB”, so as to turn it bright orange;
that described by Böhm and Herrmann in Eur. J. Org. Chem., 2000, 3679-3681, [2], for screening catalysts that are useful in the Sonogashira reaction, and which consists in revealing the product of this reaction by oxidizing it with KMnO₄, which causes a decoloration of the reaction media; and
that proposed by Löber et al. in J. Am. Chem. Soc., 2001, 123, 4366-4367, [3], for screening catalysts that are useful in the hydroamination of 1,3-dienes by arylamines such as aniline, and which consists in revealing the residual aniline by reacting it with furfural in the presence of an acid, the effect of which is to colour the reaction media red.

This second type of method exhibits, itself, the drawback of requiring reactants that are specific for one of the compounds involved in the coupling reaction or for the product formed by this reaction, which limits its use to the screening of reactions involving compounds or resulting in products for which such reactants are available.

There are also existing methods in which one of the compounds involved in the coupling reaction is attached to a solid support, while the other is labelled with a fluorescent probe. Since the two compounds are reacted, the effectiveness of the catalysis results in the formation on the solid support of the product derived from the reaction. This support must then be washed in order to eliminate the fraction of compounds that have not reacted and to detect the product derived from the reaction by reading the fluorescence present on said support.

An example of these methods is illustrated in the article by Shaugnessy et al. (J. Am. Chem. Soc., 1999, 121, 2123-2132, [4]), for screening catalysts that are useful in the Heck reaction. In this example, the first compound is an aryl halide that is attached to a crosslinked polystyrene resin (Wang resin), while the second compound is an acrylate labelled with coumarin.

The latter type of method exhibits two major drawbacks. First of all, the catalysis is carried out in a heterogeneous medium. Now, it is known that a catalyst that shows high catalytic activity in a heterogeneous medium can prove to be entirely ineffective in homogeneous medium. Moreover, the assessment of the catalysis is essentially qualitative, in that it is difficult to calculate the yield of the coupling reaction since this calculation would require knowledge of the degree of grafting of the first compound on the solid support.

Yet another type of method is based on the fact that, in the presence of an effective catalyst, the release of heat by a reaction occurs more rapidly than in the presence of an ineffective catalyst. Thus, it is possible to assess the effectiveness of catalysts by measuring the temperature variation of the reaction media, either by calorimetry or by thermography using ultrasensitive infrared cameras fixed above said reaction media.

An example of an embodiment of this type of method is illustrated in the publication by Blackmond et al. (Organic Process Research & Development, 1999, 3(4), 275-280, [5]), for screening catalysts that are useful in the Heck reaction.

Thermal analysis screening methods have the deficiency of requiring substantial and expensive material. Moreover, they do not make it possible to calculate the reaction yield. Finally, they are not applicable to reactions that take place slowly and that, as a result, give off amounts of heat that are not detectable or sufficiently significant.

Finally, is has been proposed, by Hinderling and Chen in Angew. Chem. Int. Ed., 1999, 38(15), 2253-2256, [6], to use electrospray mass spectrophotometry for carrying out the screening of olefin polymerization catalysts. Here also, it involves a method that requires substantial and expensive equipment.

There exists therefore a real need for a method that makes it possible to test the effects of various operating conditions on a coupling reaction, and more particularly the potential usefulness of catalysts in this reaction, and that, in general, is free of all the drawbacks exhibited by the screening methods proposed to date.

### DESCRIPTION OF THE INVENTION

The present invention satisfies precisely this need by providing a method of screening the operating conditions of a coupling reaction of at least two functional groups, which comprises the following steps:

i) reacting together at least two compounds:
a first compound of formula E₁-X₁-G₁ in which G₁ represents a first of said at least two functional groups, X₁ represents a covalent bond or a first spacer group, while E₁ represents the residue of a first molecule M₁ for which a first specific antibody AC₁ is available, and
a second compound of formula E₂-X₂-G₂ in which G₂ represents a second of said at least two functional groups, X₂ represents a covalent bond or a second spacer group, which may be identical to or different from X₁, while E₂ represents either the residue of a second molecule M₂ that is different from M₁ and for which a second specific antibody AC₂ is available, or a group capable of forming at least one covalent bond with the antibody AC₁ in the presence of a coupling agent;
   said at least two compounds being reacted in solution in a solvent and under predetermined operating conditions, at least one of which is a candidate operating condition, in order to obtain a reaction medium and the formation, in this medium, of a compound Z comprising the chain E₁-X₁-G₁-G₂-X₂-E₂ in which X₁, X₂, E₁ and E₂ have the same meaning as above, while G₁-G₂ represents the group of atoms resulting from the coupling of said at least two functional groups;

ii) determining the concentration of compound Z in the reaction medium at a predetermined reaction time t, by means of at least one immunoassay using at least the antibody AC₁; and

iii) evaluating the effects of the candidate operating condition(s) on said coupling reaction using the concentration of compound Z thus determined.

Thus, in the method according to the invention, the coupling reaction, for which it is desired to screen the operating conditions and which involves a minimum of two functional groups, in the case in point G₁, and G₂, is carried out using, as reactants, at least two compounds which each comprise, at one end, one of these functional groups and, at the other end, the residue of a molecule, respectively M₁ and M₂, for which a specific antibody, respectively AC₁ and AC₂, is available or, in the case of the second compound, a group capable of forming one or more covalent bonds with the antibody AC₁ specific for the molecule M₁ in the presence of a coupling agent.

The concentration, in the reaction medium, of compound Z produced by the coupling reaction can thus be readily determined, at a selected reaction time t, by means of at least one immunoassay, this assay using either only the antibody AC₁, or the two antibodies AC₁ and AC₂.

Once the concentration of compound Z is known, it is then possible to determine, by means of a calculation, the yield of the coupling reaction and to assess the effects of the operating conditions under which it has been carried out, by means of the value of this yield. These effects can, however, also be assessed by comparing said concentration with one or more concentrations obtained beforehand under different operating conditions and acting as reference values.

In the above and following text:
the term “candidate operating condition” is intended to mean an operating condition for which the effects on the coupling reaction are tested;
the term “residue” of a molecule M₁ is intended to mean the part of this molecule that remains in the compound of formula E₁-X₁-G₁ when said molecule is covalently attached either to functional group G₁, or to the spacer group, depending on whether X₁ represents a covalent bond or a spacer group; similarly, the term “residue” of a molecule, respectively M₂, M₃ or M₄, corresponds to the part of this molecule that remains in the compound of formula E₂-X₂-G₂, E₃-X₃-G₃ or E₄-X₄-G₄, respectively, when said molecule is covalently attached either to the functional group G₂, G₃ or G₄, respectively, or to the spacer group, depending on whether X₂, X₃ or X₄ represents a covalent bond or a spacer group.

Moreover, the term “antibody specific” for a molecule is intended to mean an antibody capable of specifically recognizing this molecule and of binding with it by means of an antigen-antibody immunoreaction.

As indicated above, in the compounds E₁-X₁-G₁ and E₂-X₂-G₂, G₁, and G₂ correspond to the two functional groups which are at least involved in the coupling reaction for which it is desired to screen the operating conditions, and are therefore chosen according to this reaction.

Coupling reactions involving two functional groups and for which the method according to the invention can be used are in particular the following intermolecular coupling reactions:
esterification reactions such as those which consist in coupling a carboxylic acid (R—COOH) or a carboxylic acid derivative such as, for example, an acid halide (R—CO-Hal), and an alcohol (R′—OH) so as to obtain an ester group (R—CO₂R′);
amidation reactions such as those which consist in coupling a carboxylic acid (R—COOH) or a carboxylic acid derivative and a primary (R′—NH₂) or secondary (R′—NH—R″) amine so as to obtain an amide (R—CONH—R′ or R—CONR′—R″);
aldolization reactions such as those which consist in coupling two aldehydes (R—CHO) or two ketones (R—CO—R′), or in coupling an aldehyde and a ketone so as to obtain an aldol or a ketol, and variants thereof such as the nitroaldolization reaction in which an aldehyde is coupled to a nitrogenous compound (R′—CH₂—NO₂) so as to obtain a nitro alcohol (R—CH(OH)—CH(NO₂)—R′);
the Heck reaction, which consists in coupling an olefin (R′—CH═CH₂) and an organic halide (R′-Hal) so as to obtain an alkene (R—CH═CH—R′), and its variants;
the Baylis-Hillman reaction, which consists in coupling an alkene (R—CH═CH₂) and an aldehyde (R′—CHO) so as to obtain an allyl alcohol (R′—C(CH₂)—CH(OH)—R′), and its variants;
the Michael reaction, which consists of an addition between a nucleophilic compound and an unsaturated electron-acceptor compound (for example, R—CH═CH₂), and its variants;
metathesis reactions such as those which consist in coupling two olefins (for example, R—CH═CH₂ and R′—Ch═CH₂) so as to obtain a third thereof (R—Ch═CH—R′);
the Diels-Alder reaction, which consists of a cycloaddition between a diene and a dienophile;
the Sonogashira reaction, which consists in coupling an alkyne (R—C≡CH) and an aryl halide(Ar-Hal) so as to obtain an arylalkyne (R—C═C≡Ar), and its variants;
the Suzuki reaction, which consists in coupling an arylboronic acid (Ar—B(OH)₂) and an aryl halide (Ar′-Hal) so as to obtain a diaryl (Ar—Ar′), and its variants;
the Kumada reaction, which consists in coupling a Grignard reagent (R—Mg-Hal) and an alkyl halide, vinyl halide or aryl halide, and its variants;
the Stille reaction, which consists in coupling an organostannic compound (for example, Ar—SnBu₃) and an organic halide (for example, Ar′—Br), and its variants;
the Hiyama reaction, which consists in coupling an organosilane (for example, Ar—SiR₃) and an organic halide (for example, Ar′—Br), and its variants; and
the Liebeskind-Srogl reaction, which consists in coupling a boronic acid (for example, Ar—B(OH)₂) and a thiol ester (R—CO—S—R′) so as to obtain a ketone, and its variants.

Coupling reactions involving three functional groups are in particular the Mannich reaction, which consists in coupling a compound having an active hydrogen with a non-enolizable aldehyde and a primary or secondary amine so as to obtain an aminomethyl compound, the Hantzsch reaction, which consists in coupling an amine with an aldehyde and an α-bromo ketone so as to obtain a pyrrole, and the reaction of Bossio et al., which consists in coupling an α-ketoaldehyde with a carboxylic acid and an isonitrile so as to obtain an oxazole, while a coupling reaction involving four functional groups is, for example, the Ugi reaction, which consists in coupling a carboxylic acid, a primary amine, a carbonyl compound and an isocyanide so as to obtain an α-aminocarboxamide.

Moreover, in the compounds of formulae E₁-X₁-G₁ and E₂-X₂-G₂, E₁ represents the residue of a molecule M₁ for which a first specific antibody AC₁, is available, while E₂ can represent the residue of a molecule M₂ for which a second specific antibody AC₂ is available.

These two residues must exhibit antigenic properties similar to those of the molecules M₁ and M₂ from which they are derived, so as to be recognized, respectively, by the antibody AC₁ and by the antibody AC₂, and to form with them an immunobond, but they must neither impair the progression of the coupling reaction, in particular through steric hindrance, nor interfere in this reaction.

Thus, the molecules M₁ and M₂ are preferably haptenes, i.e. small molecules which, after grafting onto a vector such as a protein (bovine serum albumin, γ-immunoglobulin, etc.) or a polysaccharide, are capable of inducing in the animal the production of antibodies specifically directed against them.

These haptenes can in particular be hydrocarbons such as naphthalene, anthracene, phenanthrene, bicyclo[2.2.2] octane, bicyclo[2.2.2] heptane, 2,2-dimethyl-3-methyl-4,4-dimethylpentane, adamantane, perhydrophenalene and perhydroanthracene, substituted with a reactive function, preferably carboxylic acid, amine or thiol, capable of allowing them, firstly, to be grafted onto the vector and, secondly, to be attached to the functional groups G₁ and G₂ or to the spacer groups when X₁ and X₂ represent such groups. Such hydrocarbons in fact have the advantage of being relatively chemically inert.

However, these haptenes can also be molecules other than hydrocarbons, in which case, if, in the compounds E₁-X₁-G₁ and E₂-X₂-G₂, the residues of these molecules comprise one or more free functional groups capable of reacting in the operating conditions under which the coupling reaction is carried out, this or these functional group(s) should be protected with a suitable protective group chosen before the coupling reaction is carried out, i.e. prior to step i) of the method, and then deprotected between steps i) and ii).

Two molecules have been found to constitute haptenes that are particularly advantageous for carrying out the method according to the invention. These are, firstly, histamine, which corresponds to formula (I) below: 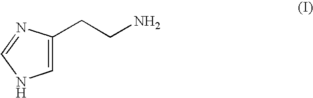
and for which it has been possible to obtain several monoclonal antibodies exhibiting a Kd at least equal to 10⁻⁸ M and, secondly, homovanillic acid, which corresponds to formula (II) below: 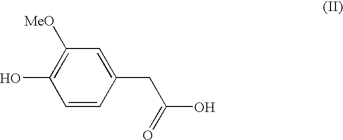
and for which it has been possible to obtain several monoclonal antibodies exhibiting a Kd at least equal to 10⁻⁶ M.

Thus, according to a first preferred arrangement of the method according to the invention, E₁ in the compound E₁-X₁-G₁ or E₂ in the compound E₂-X₂-G₂ corresponds to formula (III) below: 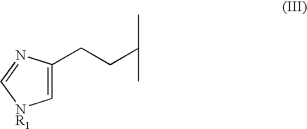
in which R₁ represents a hydrogen atom or an amine function-protecting group such as, for example, a tert-butyloxycarbonyl (BOC) group or benzyl group.

According to another preferred arrangement of the method according to the invention, E₁ in the compound E₁-X₁-G₁ or E₂ in the compound E₂-X₂-G₂ corresponds to formula (IV) below: 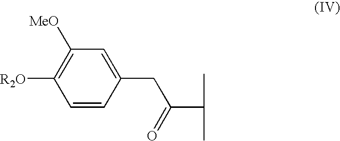
in which R₂ represents a hydrogen atom or an alcohol function-protecting group such as, for example, a silylated group of the dimethyl tert-butylsilyl type, dihydropyran or else a benzyl, allyl or acetal group.

In the compound E₂-X₂-G₂, it is possible for E₂ not to represent the residue of a molecule M₂, but a group capable of forming at least one covalent bond with the antibody AC₁ in the presence of a coupling agent, in which case this group is advantageously chosen from amine, carboxylic acid, aldehyde, thiol, phenol, alkenyl and azide groups, and photoactivatable groups such as, for example, benzophenone and arylazide groups.

Preferably, E₂ is an amine or thiol group.

As indicated above, in the compounds E₁-X₁-G₁ and E₂-X₂-G₂, E₁ and E₂ may be attached to the functional groups G₁ and G₂, either directly or via spacer groups.

These spacer groups, the only function of which is that of forming a bridge between, firstly, E₁ and the functional group G₁ and, secondly, between E₂ and the functional group G₂, are either groups devoid of any functional groups such as saturated hydrocarbon groups of the ethylene (—(CH₂)₂—), propylene (—(CH₂)₃—) or butylene (—(CH₂)₄—) type, or the like, or groups comprising one or more functional groups incapable of reacting in the operating conditions under which the coupling reaction is carried out, or else groups comprising one or more functional groups that are protected, prior to the coupling reaction being carried out, with a suitable protective group.

In accordance with the invention, said at least one immunoassay for the compound Z is preferably a solid-phase assay for reasons of simplicity of implementation.

According to a first preferred embodiment of the method according to the invention, since E₂ corresponds, in the compound E₂-X₂-G₂, to the residue of a molecule M₂, said at least one immunoassay for the compound Z is a “sandwich”-type (or two-site) assay and step ii) comprises the following steps:

a₁) bringing the reaction medium obtained at reaction time t into contact with a solid phase on which the antibody AC₁ is immobilized, so as to obtain the attachment of the compound Z on this solid phase by immunobinding between this antibody and the residue E₁ of this compound;

b₁) bringing the solid phase into contact with a conjugate comprising the antibody AC₂ coupled to a label, so as to obtain the attachment of this conjugate to this solid phase by immunobinding between this antibody and the residue E₂ of the compound Z attached to said solid phase;

c₁) measuring the amount of conjugate attached to the solid phase by means of the label coupled to the antibody AC₂; and

d₁) determining, on a standard range, the concentration of the compound Z in the reaction medium at said time t, from the amount of conjugate thus measured;

said step ii) also comprising one or more operations consisting in washing the solid phase, between steps a₁) and b₁), and between steps b₁) and c₁).

This assay therefore uses the two antibodies AC₁ and AC₂, the antibody AC₁ being immobilized on the solid phase and the antibody AC₂ being coupled to a label.

According to another preferred embodiment of the method according to the invention, since E₂ corresponds, in the compound E₂-X₂-G₂, to a group capable of forming at least one covalent bond with the antibody AC₁, said at least one immunoassay for the compound Z is an assay of “SPIE-IA” type (Solid-Phase Epitope ImmunoAssay) as described in U.S. Pat. No. 5,476,770 [7], and step ii) comprises the following steps:

a₂) bringing the reaction medium obtained at reaction time t into contact with a solid phase on which the antibody AC₁ is immobilized, so as to obtain the attachment of the compound Z to this solid phase by immunobinding between this antibody and the residue E₁ of this compound;

b₂) reacting a coupling agent with the antibody AC₁ immobilized on the solid phase and the group E₂ of the compound Z attached to this solid phase, so as to obtain the formation of one or more covalent bonds between this antibody and this group;

c₂) denaturing the immunobond which exists between the antibody AC₁ immobilized on the solid phase and the residue E₁ of the compound Z attached to said solid phase, so as to release this residue from this solid phase;

d₂) bringing the solid phase into contact with a conjugate comprising the antibody AC₁ coupled to a label, so as to obtain the attachment of this conjugate by immunobinding between said antibody and the residue E₁ of the compound Z thus released;

e₂) measuring the amount of conjugate attached to the solid phase by means of the label coupled to the antibody AC₁; and f₂) determining, on a standard range, the concentration of compound Z in the reaction medium at said time t, from the amount of conjugate thus measured;

said step ii) also comprising one or more operations consisting in washing the solid phase, between steps a₂) and b₂), b₂) and c₂), c₂) and d₂), and between steps d₂) and e₂).

This assay itself uses only the antibody AC₁, but in two different forms: a first form in which it is immobilized on the solid phase and a second form in which it is coupled to a label.

The coupling agent that is used in step b₂) may be a chemical reactant, in which case it should be bifunctional, i.e. it should comprise a first functional group capable of reacting with the group E₂ of the compound E₂-X₂-G₂, and a second functional group, identical or different from the first, capable of reacting with the antibody AC₁.

According to whether these functional groups are identical or different, they may be a homobifunctional reagent such as glutaraldehyde, difluorodinitrobenzene, bis(maleimido)hexane or disuccinimidyl suberate, or a heterobifunctional reagent such as N-succinimidyl-3-3-(2-pyridyldithio)propionate or succinimidyl-4-(N-maleimidomethyl)cyclohexane-1-carboxylate.

Glutaraldehyde or disuccinimidyl suberate is preferably used.

As a variant, the coupling agent may be irradiation, for example ultraviolet irradiation, when E₂ represents a photoactivatable group.

In step c₂), the denaturation of the immunobond that exists between the antibody AC₁ and the residue E₁ of the compound Z can be carried out conventionally by means of an appropriate reagent, or else through the reaction of ultrasound or of heat.

This reagent may be chosen from acids such as HCl, bases such as NaOH, organic solvents such as, for example, alcohols of the methanol type, surfactants, and mineral salts.

Whatever the technique chosen in order to assay the compound Z:
the antibody AC₁ and, where appropriate, the antibody AC₂ may be polyclonal or monoclonal antibodies, even though, in general, it is preferable to use monoclonal antibodies because of their greater specificity;
the immobilization of the antibody AC₁ on the solid phase can be a passive or active immobilization; thus, this immobilization can be obtained by simple adsorption of said antibody to the surface of the solid phase, by covalent bonding, via binding molecules such as the avidin-biotin system, or else via a polyhistidine tag associated with the nickel or copper/NTA (nitrilotriacetic acid) complex; when the antibody AC₁ is a monoclonal antibody, its immobilization on the solid phase can also be obtained via a polyclonal antibody adsorbed beforehand at the surface of this solid phase;
the solid phase can be any one of the solid phases conventionally used for immunoassays, such as the wall of a tube or of a well of a microtitration plate, a membrane consisting of a plastic such as polystyrene or nitrocellulose, glass beads, magnetic beads and, in general, any surface to which it is possible to attach, passively or actively, an antibody; and
the label can be an isotope such as iodine 125, chromium 51 or tritium, an enzyme such as horseradish peroxydase, alkaline phosphatase, acetylcholine esterase or glucose oxydase, a luminescent label such as pyrogallol, luminol or isoluminol, a fluorescent label such as fluoresceine, fluoresceine isothiocyanate, rhodamine or cyanin, or else a substance capable of reacting with avidin or streptavidin, such as biotin and its structural analogues; in the latter case, the avidin or streptavidin is itself labelled, for example with an enzyme or a fluorochrome.

Preferably, the antibody AC₁ and, where appropriate, the antibody AC₂ are monoclonal antibodies; the solid phase is the wall of a well of a microtitration plate; the immobilization of the antibody AC₁ is carried out by passive adsorption of this antibody at the surface of this phase and the label is an enzyme, in particular acetylcholine esterase, because of its turnover (16 000 molecules of substrate hydrolyzed per second and per site) which gives the conjugates that contain it a high specific activity.

In accordance with the invention, the method advantageously comprises an operation consisting of dilution of the reaction medium between steps i) and ii).

Moreover, the effects of the candidate operating condition(s) on the coupling reaction is(are) preferably evaluated in step iii) by determining the yield of this reaction from the concentration of compound Z in the reaction medium as determined in step ii).

This yield can, for example, be calculated by applying the following formula:

$$Yield ( \% ) = ( \frac{[ Z ] \times f}{[ {E}_{1} - {X}_{1} - {G}_{1} ]} ) \times 100$$

in which:
[Z] is the concentration of compound Z in the reaction medium as determined in step ii) and f is the dilution factor for this medium when the latter has been subjected to a dilution between step i) and step ii), while
[E₁-X₁-G₁] is the initial concentration of compound E₁-X₁-G₁ in the reaction medium.

As indicated above, the coupling reaction for which it is desired to screen the operating conditions can consist in coupling two or more than two functional groups, the number of functional groups involved in this reaction preferably being equal to 2, 3 or 4.

When the coupling reaction consists in coupling two functional groups G₁ and G₂, then:
in step i), the compounds of formulae E₁-X₁-G₁ and E₂-X₂-G₂ are reacted together so as to obtain the formation, in the reaction medium, of a compound Z which corresponds to the formula E₁-X₁-G₁-G₂-X₂-E₂ in which X₁, X₂, E₁ and E₂ have the same meaning as above and G₁-G₂ represents the group of atoms resulting from the coupling between said functional groups G₁ and G₂; while
in step ii), the concentration of compound Z in the reaction medium is determined by means of a single immunoassay, which is preferably a solid phase assay of “sandwich” type or of “SPIE-IA” type as described above.

When the coupling reaction consists in coupling three functional groups G₁, G₂ and G₃, then:
in step i), the compounds of formulae E₁-X₁-G₁ and E₂-X₂-G₂ are reacted with a third compound of formula E₃-X₃-G₃ in which X₃ represents a covalent bond or a third spacer group, which may be identical to or different from X₁ and/or X2, while E₃ represents either the residue of a third molecule M₃ which is different from M₁ and from M₂ and for which a third specific antibody AC₃ is available, or a group capable of forming a covalent bond with the antibody AC₁ in the presence of a coupling agent on the condition, however, that E₂ does not already represent such a group, so as to obtain the formation, in the reaction medium, of a compound Z corresponding to one of the formulae below: 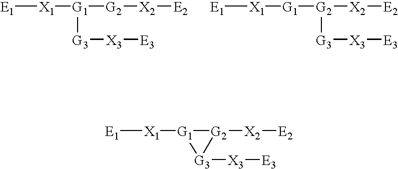
   in which X₁, X₂, X₃, E₁, E₂ and E₃ have the same meaning as above, and 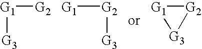
   represents the group of atoms resulting from the coupling of said functional groups G₁, G₂ and G₃; while
in step ii), the concentration of compound Z in the reaction medium is determined by means of two different immunoassays.

These assays, which may be carried out in parallel, i.e. on two different samples of the reaction medium, or one subsequent to the other on the same sample of the reaction medium, are preferably both carried out in solid phase.

Thus, they may be two “sandwich”-type assays that are carried out using:
for the first assay, the antibody AC₁ immobilized on the solid phase and the antibody AC₂ coupled to a first label, and
for the second assay, the antibody AC₁ immobilized on the solid phase and the antibody AC₃ coupled to a second label,
   the first and second labels possibly being identical when the two assays are carried out in parallel, but having to be different when they are carried out one after the other.

As a variant, the first assay may be an assay of “SPIE-IA” type which is carried out using the antibody AC₁ as described above, in which case the second assay is a “sandwich”-type assay that is carried out using the antibody AC₂ or the antibody AC₃ coupled to a label, depending on whether, in the compounds E₂-X₂-G₂ and E₃-X₃-G₃, it is E₂ or E₃ which represents the group capable of forming one or more covalent bonds with the antibody AC₁ during the “SPIE-IA” assay.

In all cases, the formation of the compound Z in the reaction medium is guaranteed by the similarity of the concentrations of this compound as determined by the two assays.

When the coupling reaction consists in coupling four functional groups G₁, G₂, G₃ and G₄, then:
in step i), the compounds of formula E₁-X₁-G₁ and E₂-X₂-G₂ are reacted with a third compound of formula E₃-X₃-G₃ as defined above and a fourth compound of formula E₄-X₄-G₄ in which X₄ represents a covalent bond or a fourth spacer group, which may be identical to or different from X₁, X₂ and/or X₃, while E₄ represents either the residue of a third molecule M₄ which is different from M₁, from M₂ and from M₃ and for which a fourth specific antibody AC₄ is available, or a group capable of forming a covalent bond with the antibody AC₁ in the presence of a coupling agent, on the condition, however, that E₂ and E₃ do not already represent such a group, so as to obtain the formation, in the reaction medium, of a compound Z corresponding to one of the formulae below: 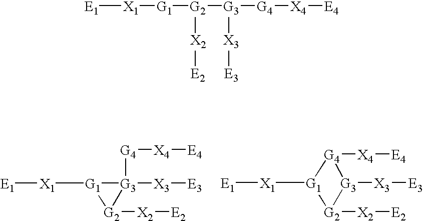
   in which X₁, X₂, X₃, X₄, E₁, E₂, E₃ and E₄ have the same meaning as above, and 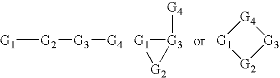
   represents the group of atoms resulting from the coupling of said functional groups G₁, G₂, G₃ and G₄; while
in step ii), the concentration of compound Z in the reaction medium is determined by means of three different immunoassays.

Here also, these assays can be carried out in parallel or one after the other and all three are preferably carried out in solid phase. They may be three “sandwich”-type assays or an assay of “SPIE-IA” type followed by two “sandwich”-type assays, the formation of the compound Z in the reaction medium being, here again, guaranteed by the similarity of the results obtained.

In accordance with the invention, the candidate operating conditions are preferably chosen from the group consisting of solvents, catalysts, temperature levels, pressure levels, the use of ultrasound, concentrations (of the substances reacted and/or of the catalyst), stoichiometric ratios (between these substances), reaction times and combinations thereof.

Thus, the method according to the invention can be used both for screening operating conditions of a single type, such as, for example, catalysts or temperature levels or pressure levels, and for screening combinations of operating conditions of different types, such as solvent/catalyst, solvent/catalyst/reaction time, temperature/pressure, or catalyst/temperature/pressure combinations, or the like.

In the text above and below, the term “catalyst” is intended to mean any agent which, merely by its presence in the reaction medium, is capable of accelerating the kinetics of a reaction.

This catalyst may be both a chemical catalyst such as, for example, an organic compound, an inorganic base, a metal, a metal salt, a metal oxide or hydride, an organometallic compound, a metal-ligand complex, a halide, or else a combination thereof, etc., and a biological catalyst, it being possible for the latter to be in very diverse forms, and in particular in the form of an organ, of a tissue, of a cell, of a cell fraction, of a cell organelle, of an enzymatic extract, of a molecular complex or else of a simple molecule, for example an isolated and purified enzyme.

The method according to the invention has many advantages. Specifically:
it makes it possible, so long as at least one molecule capable of being grafted onto a functional group, either directly or via a spacer group, and at least one antibody capable of specifically recognizing this molecule and of binding with it are available, to assay the compound resulting from the coupling of two functional groups, whatever the latter; as a result, it is sufficient to have available some graftable molecules and some antibodies specific for these molecules in order to be able to screen the operating conditions of a very large number of coupling reactions by means of the method according to the invention;
it makes it possible to simultaneously test various types of operating conditions, either in parallel or in combination, whether they are qualitative or quantitative conditions;
it is compatible with all catalytic systems, whether they are chemical or biological;
it requires no operation consisting in purifying the reaction media obtained at the end of the coupling reaction;
it makes it possible to assess the effects of the operating conditions quantitatively, by making it possible to obtain the yield of the coupling reaction;
it is very sensitive, since it has been found to allow the detection of a concentration of compound Z down to 10⁻⁹ M, which makes it possible to implement it using microvolumes of reagents and of solvents;
it is reproducible;
it is simple to carry out and requires no expensive and/or not readily available equipment;
it makes it possible to carry out screenings at a high rate; thus, its use on a relatively simple automated device, i.e. an automated device that provides washing of the solid phase, distribution of the substrate for the enzymatic label and reading of the enzyme/substrate reaction, but that does not provide distribution of the other reagents, has allowed a single experimenter to carry out about a thousand tests per day. This rate can therefore be multiplied by a factor of 10 (i.e. 10 000 tests per day) using devices that allow complete automation of the method according to the invention.

The method according to the invention is therefore particularly suitable for carrying out “high-throughout” screenings.

A subject of the invention is also a kit for carrying out a method of screening the operating conditions of a coupling reaction of at least two functional groups, which comprises suitable amounts:
of at least two compounds intended to react together:
a first compound of formula E₁-X₁-G₁ in which G₁ represents a first of said at least two functional groups, X₁ represents a covalent bond or a first spacer group and E₁ represents the residue of a first molecule M₁; and
a second compound of formula E₂-X₂-G₂ in which G₂ represents a second of said at least two functional groups, X₂ represents a covalent bond or a second spacer group, which may be identical to or different from X₁, and E₂ represents the residue of a second molecule M₂ which is different from M₁;
   of at least two antibodies:
a first antibody AC₁ specific for the first molecule M₁, this antibody being optionally attached to a plurality of solid phases; and
a second antibody AC₂ specific for the second molecule M₂, this antibody being coupled to a label;
   of a compound Z comprising the chain E₁-X₁-G₁-G₂-X₂-E₂ in which X₁, X₂, E₁ and E₂ have the same meaning as above, while G₁-G₂ represents the group of atoms resulting from the coupling of said at least two functional groups; and, optionally:
   of a reagent for visualizing the label, for example a substrate if the label is an enzyme; and
   of suitably chosen buffers (dilution buffers, rinsing buffers, etc.).

The subject of the invention is also a kit for carrying out a method of screening the operating conditions of a coupling reaction of at least two functional groups, which comprises suitable amounts:
of at least two compounds intended to react together:
a first compound of formula E₁-X₁-G₁ in which G₁ represents a first of said at least two functional groups, X₁ represents a covalent bond or a first spacer group and E₁ represents the residue of a first molecule M₁; and
a second compound of formula E₂-X₂-G₂ in which G₂ represents a second of said at least two functional groups, X₂ represents a covalent bond or a second spacer group, that may be identical to or different from X₁, and E₂ represents a group capable of forming one or more covalent bonds with an antibody specific for the molecule M₁ in the presence of a coupling agent;
   of at least one antibody, this antibody being said antibody specific for the molecule M₁;
   of a conjugate comprising said antibody specific for the molecule M₁ coupled to a label;
   of a compound Z comprising the chain E₁-X₁-G₁-G₂-X₂-E₂ in which X₁, X₂, E₁ and E₂ have the same meaning as above, while G₁-G₂ represents the group of atoms resulting from the coupling of said at least two functional groups; and, optionally:
   of a reagent for visualizing the label,
   of a coupling agent,
   of a reagent capable of denaturing an immunobond, and
   of suitably chosen buffers.

A subject of the invention is also the use of a screening method or of a kit as defined above, for the screening, in particular the “high-throughput” screening, of catalysts that are useful in a coupling reaction between two functional groups.

Besides the above arrangements, the invention also comprises other arrangements which will emerge from the additional description that follows, which relates to examples of embodiments of the method according to the invention that have made it possible to validate both its feasibility and its advantage for the “high-throughput” screening of operating conditions.

This additional description is given by way of illustration that is in no way limiting, and refers to the attached drawings.

### BRIEF DESCRIPTION OF THE DRAWINGS

FIG. 1 represents, in a diagrammatic form, the various steps of a first embodiment of the screening method according to the invention.

FIG. 2 shows the results, in terms of reaction yields, expressed as %, of a screening of operating conditions carried out in accordance with the first embodiment of the method according to the invention illustrated in FIG. 1.

FIG. 3 represents, in a diagrammatic form, the various steps of a second embodiment of the method according to the invention.

FIG. 4 shows the results, in terms of reaction yields, expressed as %, of a screening of operating conditions carried out in accordance with the second embodiment of the method according to the invention illustrated in FIG. 3.

### EXAMPLES OF EMBODIMENTS OF THE METHOD ACCORDING TO THE INVENTION

### Example 1

The present example illustrates a first embodiment of the method according to the invention in which:
the coupling reaction is the nitroaldolization reaction that is represented by: 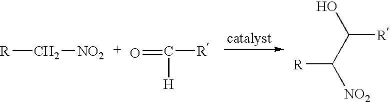
the screening relates to three types of operating conditions taken in combination, i.e. the type of solvent, the type of catalyst and the reaction time; and
the concentration of compound Z in the reaction media is determined by a “sandwich”-type solid-phase ELISA assay.

The compound E₁-X₁-G₁ corresponds to formula (V) below: 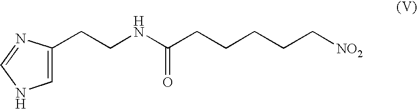
and results from the coupling of 6-nitrocaproic acid with histamine.

The compound E₂-X₂-G₂ itself corresponds to formula (VI) below: 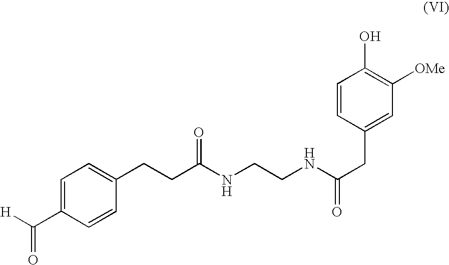
and results from the coupling of N-(2-aminoethyl)-3-(4-formylphenyl)propionamide with homovanillic acid.

The coupling reaction of the compounds E₁-X₁-G₁ and E₂-X₂-G₂ is carried out using:
two candidate solvents: tetrahydrofuran (THF) and methylene chloride (CH₂Cl₂);
twelve candidate catalysts: tetrabutyl-ammonium fluoride (TBAF), potassium fluoride (KF), triethylamine (TEA), pyridine (PYR), diisopropylamine (DIA), diazabicyclooctane (DABCO), diisopropylethyl-amine (DIEA), diazabicycloundecene (DBU), dimethyl-aminopyridine (DMAP), sodium methoxide (NaOMe), sodium hydroxide (NaOH) and potassium carbonate (K₂CO₃), and
four candidate reaction times: 30 minutes, 1 hour, 4 hours and 12 hours.

The immunoenzymatic assay of the compound Z (of formula E₁-X₁-G₁-G₂-X₂-E₂) produced by the coupling reaction is carried out using:
a monoclonal antibody directed against histamine (antibody His-31; Kd: 10⁻⁹ M), which has been immobilized on the walls of the wells of polystyrene microtitration plates (of capacity equal to 300 μl/well) by coating, i.e. by passive adsorption of this antibody at the polystyrene surface;
a conjugate comprising a monoclonal antibody directed against homovanillic acid (antibody H6-92; Kd: 10⁻⁷ M), coupled to acetylcholine esterase (AChE), this conjugate being prepared and stored as described by Taran et al. in Clin. Chem., 1997, 43(2), 363-368 [8]; and
the visualizing reagent, which comprises a mixture of 7.5H10⁻⁴ M acetylthiocholine iodide and 2.5H10⁻⁴ M 5,5′-dithiobis-(2-nitro)benzoic acid (Ellman reagent) in 0.1 M phosphate buffer (pH 7.4), in order to measure the amount of antibody H6-92/AChE conjugate attached to the solid phase.

The adsorption of the antibody His-31 to the surface of the walls of the wells of the microtitration plates was obtained by depositing 100 μl of a solution of this antibody at 5 μl/ml in 0.05 M phosphate buffer (pH 7.4) into each of these wells and leaving the plates at ambient temperature for 18 hours. Following this, the wells were washed and saturated with 300 μl of EIA buffer, and the plates were covered with scotch tape and stored at 4° C. until their use.

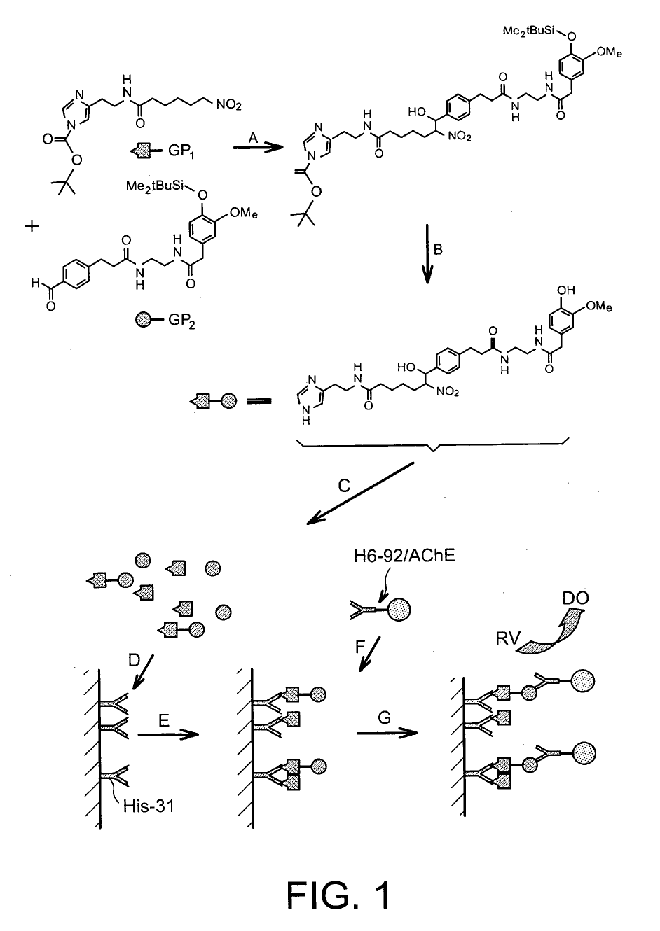

The method, the various steps of which are shown diagrammatically in FIG. 1, is carried out according to the following procedure.

1) Procedure:

Coupling Reaction (Step A of FIG. 1):

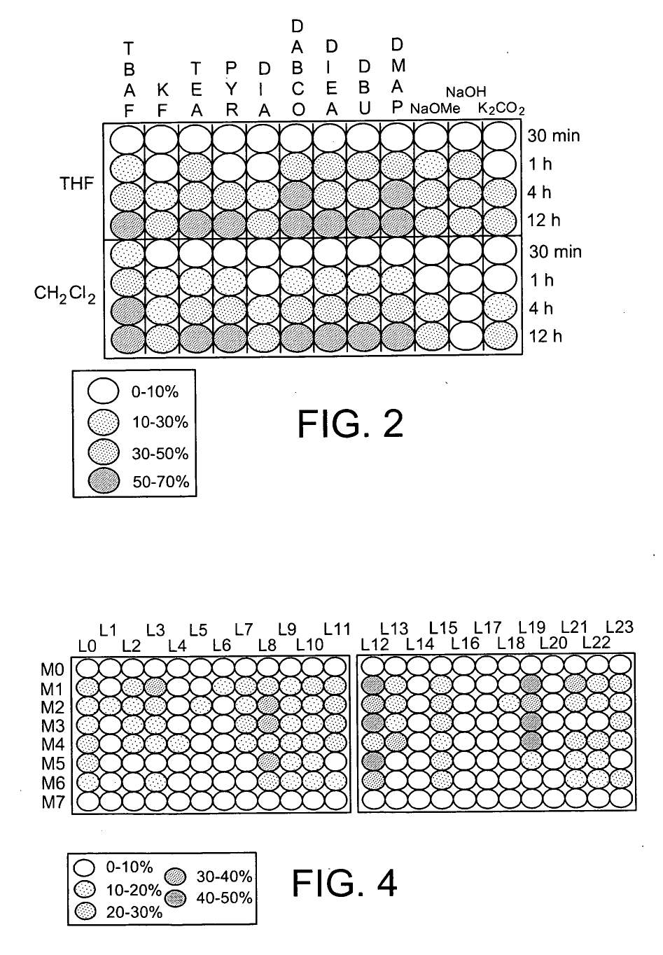

After having protected the secondary amine function carried by the nitrogenous ring of the histamine residue present in the E₁-X₁-G₁ compound (residue E₁) with a BOC group (GP₁ in FIG. 1), and the hydroxyl function carried by the ring of the homovanillic acid residue present in the compound E₂-X₂-G₂ (residue E₂) with a dimethyl tert-butylsilyl group (GP₂ in FIG. 2), the following are deposited successively in each of the wells of polypropylene microtitration plates (capacity: 300 μl/well):
50 μl of a 5 mM organic solution of the compound E₁-X-G₁,
50 μl of a 5 mM organic solution of the compound G₂-Y-E₂, and
25 μl of a 1 mM organic solution of a candidate catalyst, a single and same solvent (THF or CH₂Cl₂) being used in each well.

The microtitration plates are placed in an incubator shaker, at a temperature of 40° C., and are kept there for the desired reaction time.

Stopping the Coupling Reaction and Deprotection (Step B of FIG. 1):

The coupling reaction is stopped and the protective groups are removed by adding 125 μl of pure trifluoroacetic acid (TFA) to the wells. The plates are shaken for 15 minutes at ambient temperature.

Dilution of the Reaction Media (Step C of FIG. 1):

Each reaction medium is diluted by removing 10 μl of this medium and adding. it to 1 ml of EIA buffer (0.1 M phosphate buffer; 0.15 M NaCl; 0.1% BSA; 0.01% sodium azide; pH 7.4) contained in a deep-well plate well (capacity: 2 ml/well).

This operation is repeated twice such that each reaction medium is diluted 10⁶-fold.

Assaying of Compound Z:

50 μl of each diluted reaction medium are deposited in a well of a microtitration plate in which the wall of the wells is coated with the antibody His-31 (step D of FIG. 1).

The plate is shaken for 1 hour at ambient temperature, and then washed 5 times with a washing buffer consisting of a 0.01 M phosphate buffer, pH 7.4, containing 0.05% of Tween® 20 (step E of FIG. 1).

Next, 50 μl of a solution of the H6-92/AChE conjugate at 5 Ellman units/ml (EU), one Ellman unit being defined as the amount of enzyme capable of producing an increase in absorbance of one unit over one minute in one ml of Ellman reagent, for an optical path of one cm at 25° C. are deposited in each well (step F of FIG. 1).

The plate is shaken for 3 hours at ambient temperature, and then washed 5 times with the washing buffer (step G of FIG. 1).

200 μl of visualizing reagent (RV) are then introduced into each well. The plate is shaken for 1 hour at ambient temperature, at the end of which time the optical density (OD) at 414 nm of the medium contained in each well is measured by means of an automatic reader.

From the OD values thus obtained, the concentration of compound Z for each reaction medium is determined, with reference to a standard range (which makes it possible to relate an absorbance value to a concentration of compound Z), and then the yield of the nitroaldolization reaction is determined by means of the formula for calculating the yield mentioned above.

2) Results:

The results are given in FIG. 2, in the form of a matrix in which the reaction yields (expressed as %) are symbolized by white, light grey, medium grey or dark grey circles, depending on whether they are between 0 and 10%, between 10 and 30%, between 30 and 50% or between 50 and 70%.

These circles are distributed over 8 lines each corresponding to a candidate reaction time, and over 12 columns each corresponding to a candidate catalyst, the upper 4 lines giving the yields of the reactions carried out in THF, and the lower 4 lines giving the yields of the reactions carried out in CH₂Cl₂.

FIG. 2 shows, for example, that, when the nitroaldolization reaction is carried out for 4 hours in THF, only diazabicyclooctane (DABCO) and dimethylaminopyridine (DMAP) make it possible to obtain a reaction yield of greater than 50%, whereas, when it is carried out for the same amount of time in CH₂Cl2, such a yield is only obtained in the presence of tetrabutyl-ammonium fluoride (TBAF).

### Example 2

This example illustrates a second embodiment of the method according to the invention in which:
the coupling reaction is the Sonogashira reaction that is represented by: 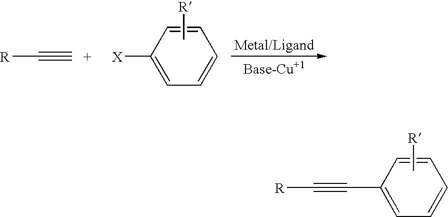
the screening relates to two types of operating conditions taken in combination, i.e. the type of solvent and the type of catalyst; and
the concentration of compound Z in the reaction media is determined by means of a solid-phase immunoenzymatic assay of “SPIE-IA” type.

In this example, the compound E₁-X₁-G₁ corresponds to formula (VII) below: 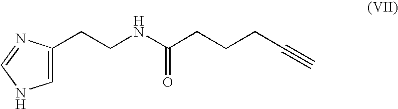
and results from the coupling of 5-hexynoic acid with histamine.

The compound E₂-X₂-G₂ itself corresponds to formula (VIII) below:

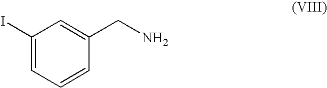

The reaction consisting in coupling the compounds E₁-X₁-G₁ and E₂-X₂-G₂ is carried out using:
three candidate solvents: dimethylformamide (DMF), dimethyl sulphoxide (DMSO) and THF;
a library of catalysts prepared in situ and in which each catalyst corresponds to a combination between:
(1) a metal complex M chosen from the complexes M₁ to M7 below:
   M1: Pd₂dba₃
   M2: Pd(PPh₃)₄
   M3: Pd(OAc)₂
   M4: PdCl₂(PPh₃)₂
   M5: PdCl₂(C₆H₅CN)₂
   M6: Pd(NH₃)₄(NO₃)₂
   M7: Ni(acac), and
(2) a ligand L chosen from the 23 ligands below:
   the ligands L1 to L12 corresponding to the formula PR₃ in which R is respectively an n-butyl, n-octyl, t-butyl, —CH₂—Ch═CH₂, —CH₂OH, —CH₂CH₂CH₂OH, —N(CH₃)₂, phenyl, o-tolyl, —Ch═CH₂, o,p-di-OCH₃C₆H₃ or o-furyl group;
   the ligands L13 to L17 corresponding to the formula R₂P(CH₂)ₙPR₂ in which R is a methyl group and n is equal to 1 or 2 (L13, L14), or R is a phenyl group and n is equal to 1, 2 or 4 (L15, L16, L17);
   the ligand L18 or the ligand DIOP of formula: 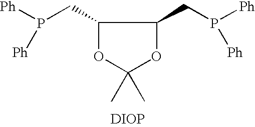
   the arsenic complexes L19 and L20 of formula AsPh₃ and (Ph₂)As(CH₂)₂As(Ph₂);
   the imidazoliums L21 to L23 corresponding to the formula: 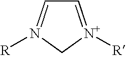
      in which R is an ethyl group and R′ is a methyl group (L21); R and R′ are t-butyl groups (L22);

R and R′ are 2,6-diisopropylbenzene groups;
(3) in the presence of a base chosen from diisopropylethylamine (DIEA) and potassium tert-butoxide (tBuOK), and of copper salts chosen from copper iodide (CuI) and copper triflate (CuOTf).

The immunoenzymatic assay for the compound Z (of formula E₁-X₁-G₁-G₂-X₂-E₂) produced by the coupling reaction is carried out using:
a monoclonal antibody directed against histamine (antibody His-76; Kd: 10⁻⁸ M), which has been immobilized on the wall of the wells of polystyrene microtitration plates (capacity: 300 μl/well) by coating, according to a technique similar to that described in Example 1;
a conjugate comprising this antibody coupled to AChE; and
the visualizing reagent described in Example 1 for measuring the amount of His-76/AChE conjugate attached to the solid phase.

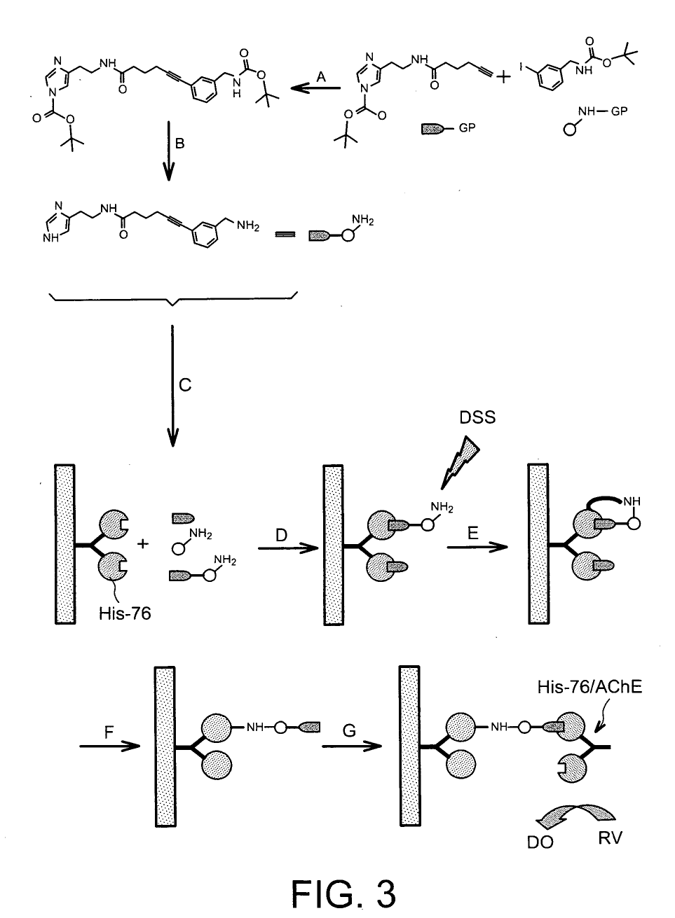

The method, the various steps of which are shown diagrammatically in FIG. 3, is carried out according to the following procedure.

1) Procedure:

Coupling Reaction (Step A of FIG. 3):

After having protected the amine function carried by the nitrogenous ring of the histamine residue present in the compound E₁-X₁-G₁ (residue E₁) A and the amine function of the compound E₂-X₂-G₂ with BOC groups (GP in FIG. 3), the following are deposited successively into each of the wells of polypropylene microtitration plates (equal capacity: 300 μl/well) and under an inert atmosphere:
5 μl of a solvent or of a 16 mM organic solution of a metal complex M,
5 μl of a solvent or of a 32 mM organic solution of a ligand L,
25 μl of an organic solution comprising the compound E₂-X₂-G₂ at 160 mM, a copper salt at 6.4 mM, a base at 480 mM, and
5 μl of an 800 mM organic solution of the compound E₁-X₁-G₁,
   a single and same solvent (DMF, DMSO or THF) being used for each well.

The plates are placed in an incubator shaker, at a temperature of 25° C., and are left there for 24 hours.

Stopping the Coupling Reaction and Deprotection (Step B of FIG. 3):

The coupling reaction is stopped and the BOC groups are removed by adding 40 μl of pure TFA to each well. The plates are shaken for 1 hour at ambient temperature.

Dilution of the Reaction Media (Step C of FIG. 3):

Each reaction medium is diluted by removing 10 μl of this medium and adding it to 1 ml of EIA buffer contained in a well of a deep-well plate (capacity: 2 ml/well).

This operation is repeated twice such that each reaction medium is diluted 10⁶-fold.

Assaying of Compound Z:

100 μl of each diluted reaction medium are deposited into a well of a microtitration plate in which the wall of the wells has been precoated with the antibody His-76.

The plates are shaken for 1 hour at ambient temperature, and then washed 5 times with washing buffer consisting of a 0.01 M phosphate buffer, pH 7.4, containing 0.05% of Tween® 20 (step D of FIG. 3).

Next, 100 μl of a 0.1 M borate buffer (pH 9) and 10 μl of a solution of disuccinimidyl suberate (DSS) at 10 mg/ml in DMF are added to each well.

The plates are shaken for 15 minutes at ambient temperature, and then washed 5 times with the washing buffer (step E of FIG. 3).

150 82 l of iN NaOH are then deposited into each well and left to act at ambient temperature for 5 minutes. At the end of this time, the plates are washed 5 times with the washing buffer (step F of FIG. 3).

100 82 l of a solution of the His-76/AChE conjugate at one Ellman unit/ml are introduced into each well and the plates are shaken at ambient temperature for 1 hour, and then washed 5 times with the washing buffer (step G of FIG. 3).

In order to measure the amount of conjugate that is attached to the solid phase, the procedure is carried out as in Example 1, the measurement of the optical density (OD) at 414 nm being carried out after 30 minutes or 1 hour of enzymatic reaction.

From the OD values thus obtained, the concentration of compound Z for each reaction medium is determined, with reference to a standard range, and then the yield of the Sonogashira reaction is determined by means of the same formula as that used in Example 1 above.

2) Results:

By way of illustration, some of the results are given in FIG. 4, in the form of a matrix in which the reaction yields (expressed as %) are symbolized by circles ranging from white to dark grey, according to whether they are between 0 and 10%, between 10 and 20%, between 20 and 30%, between 30 and 40% or between 40 and 50%.

These circles are distributed over 8 lines that correspond, for the first, to the absence of metal complex M (line M0) and, for the other 7, to one of the metal complexes M1 to M7, and over 24 columns that correspond, for the first, to the absence of ligand L (column L0and, for the other 23, to the ligands L1 to L23.

The results given in FIG. 4 are those obtained using DMF as solvent, DIEA as base, copper iodide as copper salt, 2% of metal M and 4% of ligand L.

It may be noted, in the light of these results, that two ligands (L12 and L19) are found to be the most effective when they are combined with palladium.

### BIBLIOGRAPHY

[1] Lavastre and Morken, Angew. Chem. Int. Ed., 1999, 38(21), 3163-3165
[2] Böhm and Herrmann, Eur. J. Org. Chem., 2000, 3679-3681
[3]. Löber et al., J. Am. Chem. Soc., 2001, 123, 4366-4367
[4] Shaugnessy et al., J. Am. Chem. Soc., 1999, 121, 2123-2132
[5] Blackmond et al., Organic Process Research & Development, 1999, azabicyclooctane (DABCO), diisopropylethyl-amine (DIEA), diazabicycloundecene (DBU), dimethyl-aminopyridine (DMAP), sodium methoxide (NaOMe), sodium hydroxide (NaOH) and potassium carbonate (K₂CO₃), and
   four candidate reaction times: 30 minutes, 1 hour, 4 hours and 12 hours.

The immunoenzymatic assay of the compound Z (of formula E₁-X₁-G₁-G₂-X₂-E₂) produced by the coupling reaction is carried out using:
a monoclonal antibody directed against histamine (antibody His-31; Kd: 10⁻⁹ M), which has been immobilized on the walls of the wells of polystyrene

1-26. (canceled)

27. A method of screening the operating conditions of a coupling reaction of at least two functional groups, which comprises the following steps:
i) reacting together at least two compounds:
a first compound of formula E₁-X₁-G₁ in which G₁ represents a first of said at least two functional groups, X₁ represents a covalent bond or a first spacer group, while E₁ represents the residue of a first molecule M₁ for which a first specific antibody AC₁ is available, and
a second compound of formula E₂-X₂-G₂ in which G₂ represents a second of said at least two functional groups, X₂ represents a covalent bond or a second spacer group, which may be identical to or different from X₁ while E₂ represents either the residue of a second molecule M₂ that is different from M₁ and for which a second specific antibody AC₂ is available, or a group capable of forming at least one covalent bond with the antibody AC₁ in the presence of a coupling agent;
said at least two compounds being reacted in solution in a solvent and under predetermined operating conditions, at least one of which is a candidate operating condition, in order to obtain a reaction medium and the formation, in this medium, of a compound Z comprising the chain E₁-X₁-G₁-G₂-X₂-E₂ in which X₁, X₂, E₁ and E₂ have the same meaning as above, while G₁-G₂ represents the group of atoms resulting from the coupling of said at least two functional groups;
ii) determining the concentration of compound Z in the reaction medium at a predetermined reaction time t, by means of at least one immunoassay using at least the antibody AC₁; and
iii) evaluating the effects of the candidate operating condition(s) on said coupling reaction using the concentration of compound Z thus determined.

28. The method according to claim 27, in which the coupling reaction is chosen from the group consisting of esterification reactions, amidation reactions, aldolization and nitroaldolization reactions, the Heck reaction, the Baylis-Hillman reaction, the Michael reaction, metathesis reactions, the Diels-Alder reaction, the Sonogashira reaction, the Suzuki reaction, the Kumada reaction, the Stille reaction, the Hiyama reaction, the Liebeskind-Srogl reaction, the Mannich reaction, the Hantzsch reaction, the reaction of Bossio et al., the Ugi reaction, and variants thereof.

29. The method according to claim 27, in which E₁ or E₂ represents the histamine residue.

30. The method according to claim 27, in which E₁ or E₂ represents the homovanillic acid residue.

31. The method according to claim 29, in which E₁ or E₂ corresponds to formula (III) below: 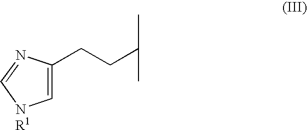
in which R₁ represents a hydrogen atom or a protective group.

32. The method according to claim 31, in which E₁ or E₂ corresponds to formula (IV) below: 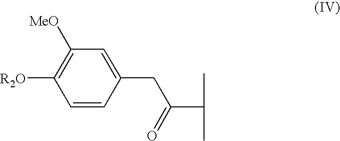
in which R₂ represents a hydrogen atom or a protective group.

33. The method according to claim 27, in which E₂ represents a group chosen from amine, carboxylic acid, aldehyde, thiol, phenol, alkenyl and azide groups, and photoactivatable groups.

34. The method according to claim 33, in which E₂ represents an amine or thiol group.

35. The method according to claim 27, in which said at least one immunoassay for the compound Z is a solid-phase assay.

36. The method according to claim 27, in which, since E₂ corresponds to the residue of a molecule M₂, step ii) comprises the following steps:
a₁) bringing the reaction medium obtained at reaction time t into contact with a solid phase on which the first antibody AC₁ is immobilized, so as to obtain the attachment of the compound Z on this solid phase by immunobinding between this antibody and the residue E₁ of this compound;
b₁) bringing the solid phase into contact with a conjugate comprising the second antibody AC₂ coupled to a label, so as to obtain the attachment of this conjugate to this solid phase by immunobinding between the second antibody AC₂ and the residue E₂ of the compound Z attached to said solid phase;
c₁) measuring the amount of conjugate attached to the solid phase by means of the label coupled to the antibody AC₂; and
d₁) determining, on a standard range, the concentration of the compound Z in the reaction medium at said time t, from the amount of conjugate thus measured;
said step ii) also comprising one or more operations consisting in washing the solid phase, between steps a₁) and b₁), and between steps b₁) and c₁).

37. The method according to claim 27, in which, since E₂ corresponds to a group capable of forming at least one covalent bond with the first antibody AC₁, step ii) comprises the following steps:
a₂) bringing the reaction medium obtained at reaction time t into contact with a solid phase on which the first antibody AC₁ is immobilized, so as to obtain the attachment of the compound Z to this solid phase by immunobinding between this antibody and the residue E₁ of this compound;
b₂) reacting a coupling agent with the first antibody AC₁ immobilized on the solid phase and the group E₂ of the compound Z attached to this solid phase, so as to obtain the formation of one or more covalent bonds between this antibody and this group;
c₂) denaturing the immunobond which exists between the first antibody AC₁ immobilized on the solid phase and the residue E₂ of the compound Z attached to this solid phase, so as to release this residue from this solid phase;
d₂) bringing the solid phase into contact with a conjugate comprising the first antibody AC₁ coupled to a label, so as to obtain the attachment of this conjugate to this solid phase by immunobinding between said antibody and the residue E₁ of the compound E₁-X-G₁-G₂-Y-E₂ thus released;
e₂) measuring the amount of conjugate attached to the solid phase by means of the label coupled to the antibody AC₁; and
f₂) determining, on a standard range, the concentration of compound Z in the reaction medium at said time t, from the amount of conjugate thus measured;
said step ii) also comprising one or more operations consisting in washing the solid phase, between steps a₂) and b₂), b₂) and c₂), c₂) and d₂), and between steps d₂) and e₂).

38. The method according to claim 27, in which the first antibody AC₁ is a monoclonal antibody.

39. The method according to claim 27, in which the second antibody AC₂ is a monoclonal antibody.

40. The method according to claim 27, in which the solid phase is the wall of a well of a microtitration plate onto which the first antibody AC₁ is adsorbed.

41. The method according to claim 36, in which the label is an enzyme, preferably acetylcholine esterase.

42. The method according to claim 27, which comprises an operation consisting of dilution of the reaction medium between steps i) and ii).

43. The method according to claim 27, in which the yield of the coupling reaction is determined from the concentration of compound Z in the reaction medium.

44. The method according to claim 27, in which the coupling reaction consists in coupling 2, 3 or 4 functional groups.

45. The method according to claim 44, in which the coupling reaction consists in coupling two functional groups G₁ and G₂, and in which:
in step i), the compounds of formulae E₁-X₁-G₁ and E₂-X₂-G₂ are reacted together so as to obtain the formation, in the reaction medium, of a compound Z which corresponds to the formula E₁-X₁-G₁-G₂-X₂-E₂ in which X₁, X₂, E₁ and E₂ have the same meaning as above and G₁-G₂ represents the group of atoms resulting from the coupling between said functional groups G₁ and G₂; while
in step ii), the concentration of compound Z in the reaction medium is determined by means of a single immunoassay.

46. The method according to claim 44, in which the coupling reaction consists in coupling three functional groups G₁, G₂ and G₃, and in which:
in step i), the compounds of formulae E₁-X₁-G₁ and E₂-X₂-G₂ are reacted with a third compound of formula E₃-X₃-G₃ in which X₃ represents a covalent bond or a third spacer group, which may be identical to or different from X₁ and/or X₂, while E₃ represents either the residue of a third molecule M₃ which is different from Ml and from M₂ and for which a third specific antibody AC₃ is available, or a group capable of forming a covalent bond with the antibody AC₁ in the presence of a coupling agent on the condition, however, that E₂ does not already represent such a group, so as to obtain the formation, in the reaction medium, of a compound Z corresponding to one of the formulae below: 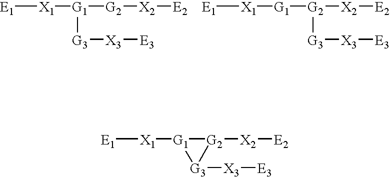
in which X₁, X₂, X₃, E₁, E₂ and E₃ have the same meaning as above, and 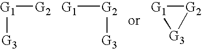
represents the group of atoms resulting from the coupling of said functional groups G₁, G₂ and G₃; while
in step ii), the concentration of compound Z in the reaction medium is determined by means of two different immunoassays.

47. The method according to claim 44, in which the coupling reaction consists in coupling four functional groups G₁, G₂, G₃ and G₄, and in which:
in step i), the compounds of formula E₁-X₁-G_{, and E}₂-X₂-G₂ are reacted with a third compound of formula E₃-X₃-G₃ as defined above and a fourth compound of formula E₄-X₄-G₄ in which X₄ represents a covalent bond or a fourth spacer group, which may be identical to or different from X₁, X₂ and/or X₃, while E₄ represents either the residue of a third molecule M₄ which is different from M₁, from M₂ and from M₃ and for which a fourth specific antibody AC₄ is available, or a group capable of forming a covalent bond with the antibody AC₁ in the presence of a coupling agent, on the condition, however, that E₂ and E₃ do not already represent such a group, so as to obtain the formation, in the reaction medium, of a compound Z corresponding to one of the formulae below: 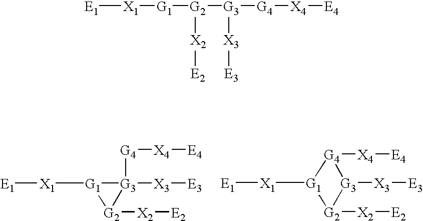
in which X₁, X₂, X₃, X₄, E₁, E₂, E₃ and E₄ have the same meaning as above, and 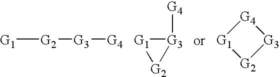
represents the group of atoms resulting from the coupling of said functional groups G₁, G₂, G₃ and G₄; while
in step ii), the concentration of compound Z in the reaction medium is determined by means of three different immunoassays.

48. The method according to claim 27, in which the candidate operating condition(s) is(are) chosen from the group consisting of solvents, catalysts, temperature levels, pressure levels, the use of ultrasound, concentrations, stoichiometric ratios, reaction times and combinations thereof.

49. The method according to claim 27, in which the candidate operating condition(s) is(are) catalysts.

50. A kit for carrying out a method of screening the operating conditions of a coupling reaction of at least two functional groups, which comprises suitable amounts:
of at least two compounds intended to react together:
a first compound of formula E₁-X₁-G₁ in which G₁ represents a first of said at least two functional groups, X₁ represents a covalent bond or a first spacer group and E₁ represents the residue of a first molecule M₁; and
a second compound of formula E₂-X₂-G₂ in which G2 represents a second of said at least two functional groups, X₂ represents a covalent bond or a second spacer group, which may be identical to or different from X₁, and E₂ represents the residue of a second molecule M₂ which is different from M₁;
of at least two antibodies:
a first antibody AC₁ specific for the first molecule M₁ this antibody being optionally attached to a plurality of solid phases; and
a second antibody AC₂ specific for the second molecule M₂, this antibody being coupled to a label;
of a compound Z comprising the chain E₁-X₁-G₁-G₂-X₂-E₂ in which X₁, X₂, E₁, and E₂ have the same meaning as above, while G₁-G2 represents the group of atoms resulting from the coupling of said at least two functional groups; and, optionally:
of a reagent for visualizing the label, for example a substrate if the label is an enzyme; and
of suitably chosen buffers.

51. A kit for carrying out a method of screening the operating conditions of a coupling reaction of at least two functional groups, which comprises suitable amounts:
of at least two compounds intended to react together:
a first compound of formula E₁-X₁-G₁ in which G₁ represents a first of said at least two functional groups, X₁ represents a covalent bond or a first spacer group and E₁ represents the residue of a first molecule M₁; and
a second compound of formula E₂-X₂-G₂ in which G2 represents a second of said at least two functional groups, X₂ represents a covalent bond or a second spacer group, that may be identical to or different from X₁, and E₂ represents a group capable of forming one or more covalent bonds with an antibody specific for the molecule Ml in the presence of a coupling agent;
of at least one antibody, this antibody being said antibody specific for the molecule M₁;
of a conjugate comprising said antibody specific for the molecule M₁ coupled to a label;
of a compound Z comprising the chain E₁-X₁-G₁-G₂-X₂-E₂ in which X₁, X₂, E₁ and E₂ have the same meaning as above, while G₁-G₂ represents the group of atoms resulting from the coupling of said at least two functional groups; and, optionally:
of a reagent for visualizing the label,
of a coupling agent,
of a reagent capable of denaturing an immunobond, and
of suitably chosen buffers.

52. A method for the screening of catalysts that are useful in a coupling reaction between two functional groups comprising utilizing the screening method according to claim 27.

53. A method for the screening of catalysts that are useful in a coupling reaction between two functional groups comprising utilizing the kit according to claim 50.
